(19) United States
(12) Patent Application Publication
(10) Pub. No.: US 2026/0061757 A1
(43) Pub. Date: Mar. 5, 2026

(54) Media Processing Device with Temperature Compensation

(71) Applicant: ZEBRA TECHNOLOGIES CORPORATION, Lincolnshire, IL (US)

(72) Inventors: Jinqiang Huang, Taiping/Guangzhou (CN); Zi Yang, Guangzhou (CN); Hongqiang Liu, Guangzhou (CN); Changyan Huang, Guangzhou (CN)

(21) Appl. No.: 18/818,546

(22) Filed: Aug. 28, 2024

(51) Int. Cl. B41J 11/00

(52) U.S. Cl. CPC B41J 11/00212; B41J 11/00216; B41J 11/00218

(57) ABSTRACT

A media processing device is configured with a temperature compensation component that operative to counteract a temperature of an environment by raising the temperature within a housing of the media processing device. The temperature compensation component selectively operated such that the temperature compensation component is configured to operate when a temperature within the housing or external to the housing falls below a specified activation temperature threshold.

### BACKGROUND

Printers are designed and known to be used in traditional office environments. However, some printers may be used in less traditional environments. Additionally, some printers have a portable design that allow them to be used for many other applications beyond traditional office printing, such as printing customer receipts at the point of delivery, price tags at product display shelves, shipment labels, parking garage receipts, adhesive labels, law enforcement tickets, and gas and utility inspection documents at people's homes. In some instances, printers can be operated in harsh environmental conditions which can impact the functionality of the printer and/or degrade the performance of the printers.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example media processing device in accordance with embodiments of the present disclosure.

FIG. 2 is a block diagram of example temperature compensation circuitry of the media processing device in accordance with embodiments of the present disclosure.

FIG. 3 is a block diagram of another example temperature compensation circuitry of the media processing device in accordance with embodiments of the present disclosure.

FIG. 4 illustrates a position of example electrothermal elements relative to an example housing of a media processing device in accordance with embodiments of the present disclosure.

FIG. 5 is a flowchart illustrating an example process for temperature compensation within a housing of a media processing device in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of media processing devices of the present disclosure can process (e.g., print, encode, etc.) media by drawing the media from the media source and routing the media proximate various processing components (e.g., printhead, RFID reader/encoder, magnetic stripe reader/encoder etc.). Processing the media from the media source may facilitate a continuous or batch printing process. As an example, embodiments of media processing devices of the present disclosure can be configured to print and/or encode media drawn from a media source, such as roll, spool, or fanfold. Such media can include a continuous web such as a spool of liner-back media or linerless media. In some embodiments, the media can include individual labels disposed on a continuous liner web. In some embodiments, media can be linerless. For thermal transfer printing, the printable surface of the media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media. The media processing device can include a battery that powers the electronics of the media processing device.

The media is routed along a feed path from the media supply to a print position located adjacent to the printhead (e.g., a thermal printhead). The media can be pulled through the feed path by a platen roller driven by a motor, where an operation of the motor is controlled by a processing device. The printhead is generally configured to form a nip with the platen roller to pinch the media between the printhead and the platen roller. This pinching or compressive force provides adequate print quality, and in some applications, ensures that a sufficient tension is maintained the continuous web. Once printed via the printhead, the printed portion of the media is advanced outwardly from the printer through a media outlet by the platen roller where it can be peeled from the liner, cut, and/or torn to separate the printed media from the media supply.

Media processing devices can have an operating temperature range within which the media processing device is configured to operate according to operating specification. As an example, a media processing device may be specified to have an operating temperature range of −10 degree Celsius to 50 degree Celsius or −15 degree Celsius to 50 degree Celsius. In some instances, it may be desirable or necessary for media processing devices to operation in an environment where the temperature approaches and/or is below a lower temperature limit of the operating range. In such environments, the functionality and performance of media processing devices can begin to degrade as a temperature of the environment approaches and/or falls below the lower temperature limit of the operating temperature range. As a non-limiting example, a print quality and/or a speed at which the media processing device can print can suffer when the temperature approaches and/or is below the lower temperature limit of the operating temperature range. As another example, the media processing device may simply cease operating. Additionally, at temperatures near or below the lower temperature limit of the operating temperature limit, the media can be less pliable or flexible which can create media handling issues and/or contributed to a degradation in print quality and/or print speed. As a result, performance of print jobs at temperatures near or below the lower temperature limit can be degraded or inhibited.

To improve an operation of media processing devices in cold environments, embodiments of the present disclosure provide for a media processing device with a temperature compensation component that operative to counteract the temperature of the environment by raising the temperature within a housing of the media processing device. The temperature compensation component selectively operated such that the temperature compensation component is configured to operate when a temperature within the housing or external to the housing falls below a specified threshold temperature which may be equal to, less than, or greater than a lower temperature limit of the operating temperature range of the media processing device. By counteracting the temperature of the environment, a temperature of the components of the media processing device can be increased, and such an increase in temperature of the components can improve the functionality and/or performance of the media processing device.

In accordance with embodiments of the present disclosure, a media processing device is disclosed. The media processing device includes an electrothermal heating element, a temperature sensor, a printhead, a battery, a logic circuit, and a housing. The logic circuit is operatively coupled to the electrothermal heating element, the temperature sensor, the printhead, and the battery. The housing defines at least one compartment containing the electrothermal heating element, the temperature sensor, and at least one of the printhead, battery, the logic circuit, or a media supply. The logic circuit is configured to receive power from the battery; control the printhead to perform print jobs, performance of the print jobs being degraded or inhibit below a specified temperature; determine whether an output of the temperature sensor corresponds to a sensed temperature that is equal to or less than an activation temperature threshold; and activate the electrothermal heating element in response to determining that the sensed temperature that is below an activation temperature threshold, the electrothermal heating element radiating heat within the at least one compartment in response to being activated.

In accordance with embodiments of the present disclosure, a media processing device is disclosed. The media processing device includes a printhead, a battery, a temperature compensation circuit, a logic circuit, and a housing. The temperature compensation circuity includes a temperature sensing circuit and an electrothermal circuit. The logic circuit is operatively coupled to the temperature compensation circuit, the printhead, and the battery. The housing contains the temperature compensation circuit, the printhead, the battery, and the logic circuit. The logic circuit is configured to receive an output voltage from the temperature sensing circuit, the voltage representative of a sensed temperature; determine whether the output voltage is indicative of a sensed temperature that is equal to or less than an activation temperature threshold; and activate the electrothermal circuit in response to determining that the sensed temperature that is below an activation temperature threshold, the electrothermal circuit including an electrothermal heating element that radiates heat within the housing in response to the electrothermal circuit being activated.

In accordance with embodiments of the present disclosure, a method is disclosed. The method includes sensing a temperature proximate to one or more components within a housing of a media processing device, performance of print jobs by the media processing device being degraded or inhibit below a specified temperature; determining whether the sensed temperature is below an activation temperature threshold; and activating the one or more electrothermal elements within the housing of the media processing device to increase the temperature proximate to the one or more components within the media processing device.

In accordance with embodiments of the present disclosure, the electrothermal heating element includes a carbon-based material. In accordance with embodiments of the present disclosure, the carbon-based material is at least one of carbon fiber, graphene, or graphite.

In accordance with embodiments of the present disclosure, the electrothermal heating element is affixed to or embedded in the housing.

In accordance with embodiments of the present disclosure, at least a portion of the electrothermal heating element is spaced away from the housing.

In accordance with embodiments of the present disclosure, the temperature sensor includes a negative temperature coefficient (NTC) thermistor.

In accordance with embodiments of the present disclosure, the logic circuit is configured to control a temperature of the electrothermal heating element when it is activated.

In accordance with embodiments of the present disclosure, the activation temperature threshold is approximately zero degrees Celsius.

In accordance with embodiments of the present disclosure, the activation temperature threshold is approximately negative ten degrees Celsius.

In accordance with embodiments of the present disclosure, the activation temperature threshold is approximately negative fifteen degrees Celsius.

In accordance with embodiments of the present disclosure, the activation temperature threshold is between negative twenty degrees Celsius and zero degrees Celsius.

In accordance with embodiments of the present disclosure, the logic device is configured to determine whether an output of the temperature sensor corresponds to a sensed temperature that is equal to or greater than a deactivation temperature threshold and deactivate the electrothermal heating element in response to determining that the sensed temperature that is equal to or greater than the deactivation temperature threshold.

In accordance with embodiments of the present disclosure, the deactivation temperature threshold is equal to the activation temperature threshold.

In accordance with embodiments of the present disclosure, the deactivation temperature threshold is greater than the activation temperature threshold.

In accordance with embodiments of the present disclosure, the deactivation temperature threshold is zero degree Celsius and seven degree Celsius.

In accordance with embodiments of the present disclosure, the electrothermal heating element corresponds to a first electrothermal element and the media processing device further comprises a second electrothermal heating element.

In accordance with embodiments of the present disclosure, the second electrothermal heating element is activated by the logic circuit in unison with the first electrothermal heating element.

In accordance with embodiments of the present disclosure, the second electrothermal heating element is activated by the logic circuit in independently of the first electrothermal heating element.

In accordance with embodiments of the present disclosure, the first compartment contains the battery and the second compartment contains the logic circuit.

In accordance with embodiments of the present disclosure, the at least one compartment of the housing corresponds to a first compartment and the housing further defines a second compartment, the second electrothermal heating element is disposed in the second compartment.

In accordance with embodiments of the present disclosure, the first compartment contains at least one of the battery or the logic circuit and the second compartment is configured to contain the media supply.

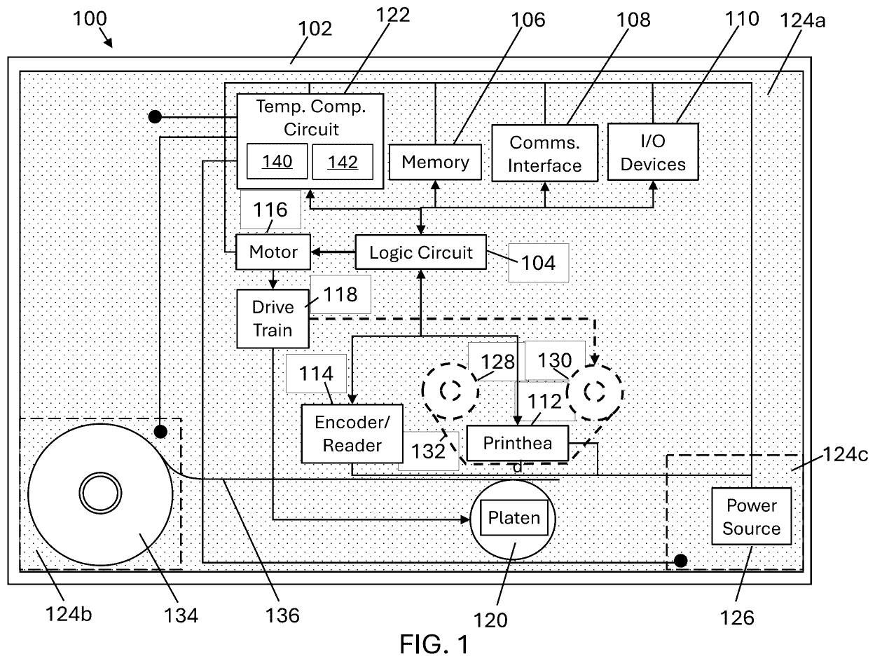

FIG. 1 illustrates a block diagram of an example media processing device 100, such as a printer, in accordance with embodiments of the present disclosure. The media processing device 100 can include a housing 102. The housing 102 can include one or one housing components and can define one or more compartments within the housing 102. The housing 102 contains or supports one or more components of the media processing device 100 including, for example, a logic circuit 104, memory 106, a communication interface 108 (e.g., for wired and wireless communication), input/output (I/O) devices 110 (e.g., a display, switches, buttons, speakers, microphone, etc.), a printhead 112, a radiofrequency encoder/reader 114, a motor 116, a drive train 118, a platen roller 120, a temperature compensation circuit 122 (including electrothermal elements 124a-c), a power source 126 (e.g., a battery). The printhead 112 and the platen roller 120 can form a nip. In some embodiments, for thermal transfer printing, the media processing device 100 can include a ribbon supply spindle 128 and a ribbon take up spindle 130 for supporting an ink ribbon 132. For direct thermal embodiments, the media processing device 100 can be devoid of the ribbon supply spindle 128, the ribbon take-up spindle 130, and the ink ribbon 132. The housing 102 can also be configured to contain a media supply 134. As an example, the housing 102 can include a media chamber to store the media supply 134 as it is consumed by the media processing device 100. The power source 126 can be a battery that is configured to power one or more of the components of the media processing device 100. As an example, the power source 126 can directly or indirectly power the logic circuit 104, the memory 106, the communication interface 108, the input/output (I/O) devices 110, the printhead 112, the radiofrequency encoder/reader 114, the motor 116, and/or the temperature compensation circuit 122. In some embodiments, an external power source (e.g., line voltage from a power grid) can be used to power the components of the media processing device 100 instead of or in addition to the power source 124. The logic circuit 104 can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 106 is a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device).

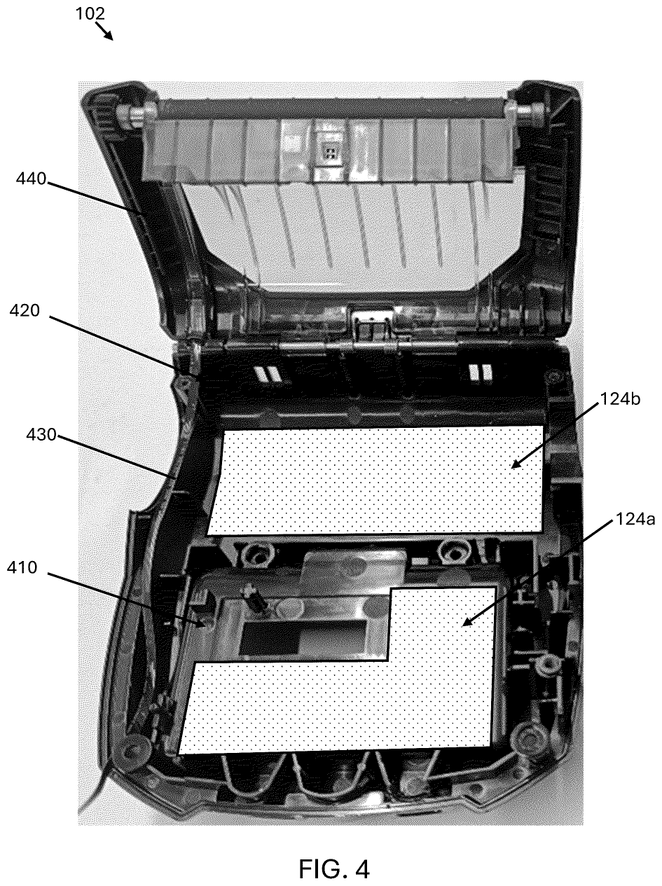

The logic circuit 104 of the media processing device 100 can be operatively coupled to the memory 106, the communications interface 108, the I/O devices 110, the printhead 112, the radiofrequency encoder/reader 114, the motor 116, and/or the temperature compensation circuit 122. The platen roller 120 can be driven by the motor 116 via a drive train 118 to rotate the platen roller 120 about an axis of rotation in a first direction (e.g., clockwise in the orientation shown in FIG. 1) to pull the media 136 through the feed path and can be driven by the motor 116 via the drive train 118 to rotate the platen roller 120 about the axis of rotation in a second direction (e.g., counterclockwise in the orientation shown in FIG. 4) to retract the media 136. In one example, the logic circuit 104 can be configured to execute code stored in the memory 106 to perform operations and functions of the media processing device 100, e.g., by communicating with and/or controlling one or more of the components of the media processing device 100. The logic circuit 104 can execute the code stored memory 106 to implement a printing operation or function that controls the motor 116 to rotate the platen roller 120 to feed the media 136 past the printhead 112, controls the print head 112 to print on the media 136 (either directly or by transferring an ink from a ribbon to the media), and/or controls the RF encoder/reader 114 to encode and/or read radiofrequency circuits (e.g., RFID or NFC tags or inlays) included in or on the media 136. For thermal transfer printing, the printable surface of the media 136 is configured to receive a pigment (e.g., resin, wax-resin, etc.) that is transferred from the ink ribbon 132 installed on the ribbon supply and take-up spindles 128 and 130, respectively, via an operation of the printhead 112. For direct thermal printing, the printhead 112 of the media processing device 100 can selectively heat the printable surface of the media 136 triggering a chemical or physical change in a thermally sensitive dye covering at least a portion of the printable surface of the media 136. After printing on the media 136, the media can be further advanced and output from media processing device 100 by the operation of the platen roller 120.

The temperature compensation circuit 122 can include the thermal elements 124, one or more temperature sensors 140, and one or more thermal activators 142. The one or more thermal activators 142 of the temperature compensation circuit 122 be activated to selectively energize the one or more of the electrothermal elements 124a-c in response to activation criteria, which can include an output of the one or more temperature sensor 140. In one example, the activation criteria includes a first specified threshold temperature (an activation temperature threshold), and the one or more thermal activators 142 of the temperature compensation circuitry 122 are configured to be activated to selectively energize the one or more of the electrothermal elements 124a-c when one or more sensed temperatures from the one or more temperature sensors 140 are equal to or less than a first specified threshold temperature. The activation temperature threshold can be, for example, between negative twenty degrees Celsius and zero degrees Celsius. As an example, the activation temperature threshold can be zero degrees Celsius, negative ten degree Celsius, or negative fifteen degrees Celsius. In one example, the activation criteria include satisfaction of the first specified threshold temperature for a specified time period, and the one or more thermal activators 142 of the temperature compensation circuitry 122 are configured to be activated to selectively energize one or more of the electrothermal elements 124a-c when the one or more sensed temperature, as determined via the one or more temperature sensors 140, are equal to or less than a first specified threshold temperature for the specified time period. When the electrothermal elements 124a-c are selectively energized via the one or more thermal activators, a temperature of the electrothermal elements 124a-c can increase to counteract the sensed temperature, generating heat within the housing 102 of the media processing device 100. In one example, a temperature of the electrothermal elements 124a-c can be controlled by the one or more thermal activators 142 of the temperature compensation circuit 122. For example, the temperature of the electrothermal elements 124a-c can be controlled based on an amount of electrical current (or average electric current) that is flowing through the electrothermal elements 124a-c. The heat from the activated electrothermal elements 124a-c can increase a temperature surrounding one or more components of the media processing device 100 within the housing 102 and/or can increase a temperature of the one or more components, such as the logic circuit 104, the memory 106, the communications interface 108, the I/O devices 110, the printhead 112, the radiofrequency encoder/reader 114, and/or the motor 116. The electrothermal elements 124a-c can also increase a temperature surrounding the media supply 134 and/or can increase the temperature of the media supply 134.

The electrothermal elements 124a-c can be included within the housing 102 and disposed proximate to various components. As an example, the electrothermal element 124a can be disposed proximate to the electronic circuit components (e.g., the logic circuit 104, the memory 106, the communication interface 108, the input/output (I/O) devices 110, the printhead 112, the radiofrequency encoder/reader 114, the motor 116, and/or the temperature compensation circuit 122), the electrothermal element 124b can be disposed proximate to the media supply 134, and/or the electrothermal element 124c can be disposed proximate to the power source 124c. The electrothermal elements 124a-c can be separate and distinct elements. The housing 102 can define a compartment for the electronic components and the electrothermal element 124a, a compartment for the media supply and the electrothermal element 124b, and/or a compartment for the battery and the electrothermal element 124c. The temperature compensation circuitry 122 can be operative to collectively activated the electrothermal elements 124a-c together and/or can be operative to independently activated the electrothermal elements 124a-c. As an example, the temperature compensation circuitry 122 can be activated in response to a single sensed temperature from one of the one or more temperature sensors 140 and can selectively energize each of the electrothermal elements 124a-c upon activation via the one or more thermal activators 142. As another example, the temperature compensation circuitry 122 can be activated in response to multiple sensed temperatures via multiple of the one or more temperature sensors 140 and can independently energize the electrothermal elements 124a-c upon activation via the one or more thermal activators 142 based on one of the sensed temperatures from a corresponding one of the one or more temperature sensors 140. As another example, the temperature compensation circuitry 122 can be activated in response to two sensed temperatures from two temperature sensors of the one or more temperature sensors 140 and can collectively energize the electrothermal elements 124a and 124c together via a first one of the one or more thermal activators 142 in response the sensed temperatures from the two temperature sensors and can independently energize the electrothermal element 124b upon activation via a second one of the one or more thermal activators 142 based on the sensed temperatures from a third temperature sensor of the one or more temperature sensors 140.

The temperature compensation circuitry 122 can remain activated (e.g., continue to energize one or more of the electrothermal elements 124a-c) until deactivation criteria is satisfied upon which the temperature compensation circuitry 122 can be deactivated. In one example, the deactivation criteria can include a second specified temperature threshold (e.g., a deactivation threshold), where the temperature compensation circuitry 122 can remain activated (e.g., continue to energize one or more of the electrothermal elements 124a-c) until the sensed temperature exceeds the second specified temperature threshold upon which the temperature compensation circuitry 122 can be deactivated. In one example, the deactivation criteria can include the second specified temperature threshold (e.g., a deactivation temperature threshold) that is identical to the first specified temperature threshold (e.g., activation temperature threshold). In one example, the second specified temperature threshold (deactivation temperature threshold) is greater than the first specified temperature threshold (activation temperature threshold), where the temperature compensation circuitry 122 can remain active (e.g., continue to energize one or more of the electrothermal elements 124a-c) until the sensed temperature exceeds a second specified temperature threshold that is greater than the first specified threshold temperature upon which the temperature compensation circuitry can be deactivated. In one example, the deactivation criteria can include the first or second specified the temperature compensation circuitry 122 can remain active (e.g., continue to energize one or more of the electrothermal elements 124a-c) until the sensed temperature exceeds the first specified threshold temperature or the second specified temperature threshold for a specified time period upon which the temperature compensation circuitry 122 can be deactivated. In one example, the deactivation temperature threshold can be between zero degrees Celius and seven degrees Celsius.

Similar to a manner in which the electrothermal elements are selectively energized (e.g., collectively and/or independently), the temperature compensation circuitry 122 can be operative to collectively de-energize the electrothermal elements 124a-c together and/or can be operative to independently de-energize the electrothermal elements 124a-c. As an example, the temperature compensation circuitry 122 can be deactivated via the one or more thermal activators 142 in response to a single sensed temperature from one of the one or more temperature sensors 140 and can de-energize each of the electrothermal elements 124a-c upon deactivation. As another example, the temperature compensation circuitry 122 can be responsive to multiple sensed temperatures from multiple of the one or more temperature sensors 140 and can independently de-energize the electrothermal elements 124a-c via multiple of the one or more thermal activators 142 based on the sensed temperatures from corresponding ones of the one or more temperature sensors 140. As another example, the temperature compensation circuitry 122 can be responsive to two sensed temperatures from two temperature sensors of the one or more temperature sensors 140 and can collectively de-energize the electrothermal elements 124a and 124c together via a first one of the one or more thermal activators 142 based on the sensed temperatures from the two temperature sensors and can independently de-energize the electrothermal element 124b via a second one of the one or more thermal activators 142 based on the sensed temperature from a third temperature sensor of the one or more temperature sensors 140.

While an embodiment of the media processing device 100 is illustrated as including electrothermal elements 124a-c, embodiments of the present disclosure can include more or fewer electrothermal elements. As an example, an embodiment of the media processing device 100 can include a single electrothermal element 124 which can be disposed proximate to the electronic circuitry, the media supply 134, and/or the power supply 126. As another example, an embodiment of the media processing device 100 can include two electrothermal elements, where the first electrothermal element is disposed proximate to the electronic circuit components and the power source 126 and the second electrothermal element 124 is disposed proximate to the media supply 134. As another example, an embodiment of the media processing device 100 can include four electrothermal elements 124, where the first electrothermal element is disposed proximate to the logic circuit 104, the memory 106, the communication interface 108, and/or the I/O device 110, the second electrothermal element can be disposed proximate to the printhead 112 and/or the encoder/reader 114, the third electrothermal element can be disposed proximate to the power source 126, and the fourth electrothermal element can be disposed proximate to the media supply 134.

In some embodiments a configuration of the housing 102 can define different compartments or areas and the electrothermal elements can be disposed in the housing 102 to accommodate the different compartments or areas. As an example, the housing 102 can define a media supply compartment and an electronics compartment, where the media supply compartment and the electronics compartment each define a separate and distinct area within the housing 102. To accommodate the separate areas, the electrothermal elements 124a and/or 124b can be disposed in the electronics compartment of the housing 102 and the electrothermal element 124c can be disposed in the media supply compartment of the housing 102.

The electrothermal elements 124a-c can be formed from one or more electrothermal materials. As an example, the electrothermal elements 124a-c can be formed from one or more carbon-based materials, such as carbon fiber, graphite, graphene, and the like. Carbon-based materials, such as carbon fiber, which is a fibrous material composed of carbon elements, can have high strength, high stiffness, a low specific gravity, and excellent electrical and thermal conductivity. As an example, when electric current passes through a carbon fiber element, electrons move at high speed inside the carbon fiber, generating a large amount of heat energy through friction, which causes the temperature of the carbon fiber element to increase. Simultaneously, the carbon fiber element converts electrical energy into heat energy through the principle of electrothermal conduction, causing the surface temperature of the carbon fiber element to rise. In addition, the carbon fiber element also transfers heat via infrared radiation, enhancing the heating effect. In one example, when a voltage of 5 V is applied to a carbon fiber element a current of approximately 0.7 A flows through the carbon fiber element (approximately 3.5 W), which results in a temperature of up to 102° C. at the surface of the carbon fiber element. In one example, the carbon fiber elements can have a thickness of between approximately 0.05 mm and approximately 0.2 mm or can have a thickness of approximately 0.1 mm. In one example, carbon-based elements can be disposed on an interior surface of the housing 102. In one example, the carbon-based elements can be embedded in or integrated with the housing 102. In one example, the carbon-based elements can be disposed on a frame or other structure within the housing.

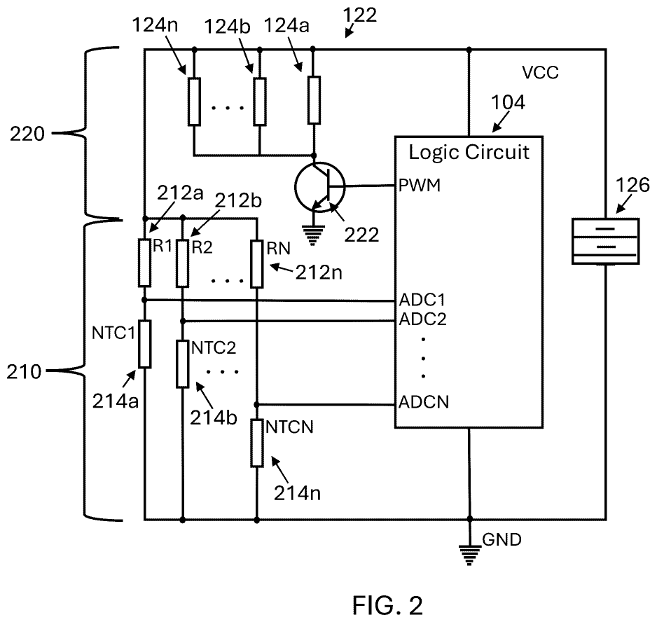

FIG. 2 is a block diagram of an embodiment of the temperature compensation circuitry 122 in accordance with embodiments of the present disclosure. As shown in FIG. 2, the temperature compensation circuitry 122 can include a temperature sensing circuit 210 and an electrothermal circuit 220. The temperature sensing circuitry 210 can include resistors 212a-212n and negative temperature coefficient (NTC) thermistors 214a-214n. The resistors 212a-212n and NTC thermistors 214a-214n can be arranged into N circuit branches where each circuit branch can include at least one of the resistors and at least one of the NTC thermistors. As an example, in FIG. 2, a first branch can include the resistor 212a and the NTC thermistor 214a, a second circuit branch can include the resistor 212b and the NTC thermistor 214b, and an n^{th} circuit branch can include the resistor 212n and the NTC thermistor 214n. A electrical resistance of the NTC thermistors can change based on a temperature. The NTC thermistors 214a-214n can be disposed at different locations within the housing 102 of the media processing device 100 to sense a temperature at the different locations within the housing 102 (e.g., an NTC thermistor can be disposed proximate to the power source 126 and/or electronic components and another one of the NTC thermistors can be disposed proximate to the media supply 134.

Output nodes of the circuit branches are disposed between the resistors 212a-n and the corresponding NTC thermistors 214a-n and can be operatively coupled to analog-to-digital converters (ADCs), which in the present example, can be included in the logic circuit 104. Because the electrical resistance of the NTC thermistors 214a-n varies based on temperature, voltages at the output nodes can vary proportionally to the change in resistance of the NTC thermistors 214a-n, and can be representative of corresponding temperatures sensed by the NTC thermistors 214a-n. The digitized outputs of the ADCs (corresponding to the voltages at the output nodes) can be compared to a first specified threshold voltage value (representative of a first specified temperature threshold).

The electrothermal circuit 220 can include the electrothermal elements 124a-124n and a transistor 222. The electrothermal elements 124a-124n can be operatively coupled between, e.g., a supply voltage (VCC) and the transistor 222, where the transistor can be controlled by the logic circuit 104 to selectively isolate the electrothermal elements from ground (GND) and selectively connect the electrothermal elements to ground. While an example of the electrothermal circuit is illustrated with the transistor 222 electrically disposed between the electrothermal elements 124a-n and ground, in exemplary embodiments, the transistor 222 can be electrically disposed between the supply voltage and the electrothermal elements 124a-n such that the transistor 222 selectively isolates the electrothermal elements from the supply voltage and selectively connects the electrothermal elements to supply voltage. When the electrothermal elements 124a-n are isolated from the supply voltage and/or ground, no electrical current flow through the electrothermal elements 124a-n and the electrothermal elements 124a-n do not generate heat. When the electrothermal elements are electrically connected to the supply voltage and ground, electrical current flows through the electrothermal elements 124a-n and the electrothermal elements generate heat. A signal used to control the transistor 222 to selectively couple the electrothermal elements 124a-n between the supply voltage and ground can be generated by the logic circuit 104 in response to one, some, or all of the voltages at the output nodes of the temperature sensing circuit 210 correspond to temperature that is below a first specified temperature. In one example, the logic circuit 104 can generate a pulse width modulated (PWM) signal that cause the transistor switch between electrically isolating and connecting the electrothermal elements 124a-124n between the supply voltage and ground. In one example, the PWM signal can be specified to generate a specified average electrical current through the electrothermal elements 124a-n over time such that a temperature of the electrothermal elements 124a-n reaches a specified temperature.

While the logic circuit 104 is illustrated as controlling an operation of the transistor 222 to activate and/or deactivate the electrothermal elements 124a-124n, the logic circuit 104 can continue to monitor the voltages at the output nodes of the temperature sensing circuit 210. When the voltage(s) of one, some, or all of the of the output nodes corresponds to the sensed temperature that is above a second threshold temperature (e.g., deactivation temperature threshold), the logic circuit 104 can deactivate the electrothermal elements 124a-c by ceasing output of the signal controlling the transistor and can control the transistor 222 to electrically isolate the electrothermal elements 124a-n from the supply voltage and/or ground.

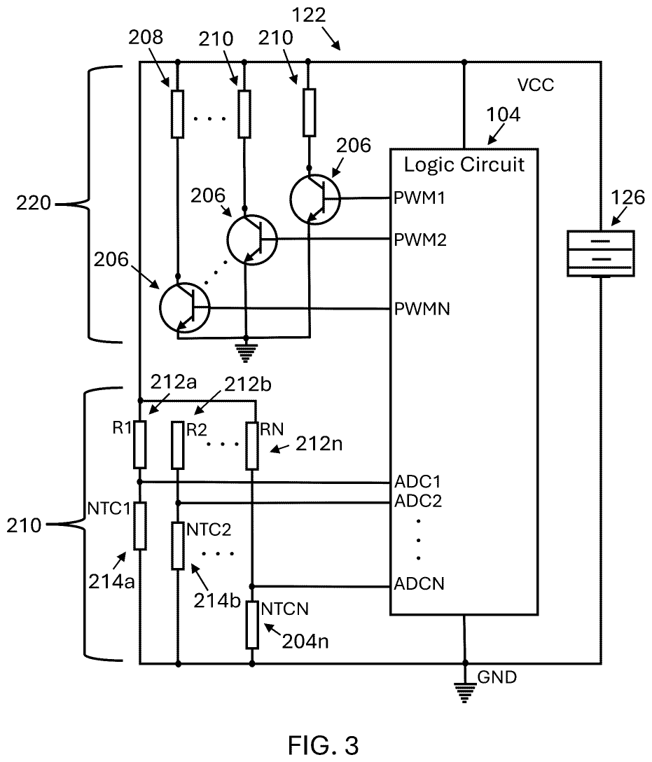

FIG. 3 is a block diagram of another embodiment of the temperature compensation circuitry, which operates in a similar manner to the embodiment of the temperature compensation circuit of FIG. 2, except that each of the electrothermal elements 124a-n are individually energized or de-energized by a corresponding transistor 222a-n. With reference to FIG. 3, the temperature sensing circuit can have a first branch including the resistor 212a and the NTC thermistor 214a, a second circuit branch including the resistor 212b and the NTC thermistor 214b, and an n^{th} circuit branch including the resistor 212n and the NTC thermistor 214n. An electrical resistance of the NTC thermistors can change based on a temperature. The NTC thermistors 214a-214n can be disposed at different locations within the housing 102 of the media processing device 100 to sense a temperature at the different locations within the housing 102 (e.g., an NTC thermistor can be disposed proximate to the power source 126 and/or electronic components and another one of the NTC thermistors can be disposed proximate to the media supply 134. The output nodes of the circuit branches are disposed between the resistors 212a-n and the corresponding NTC thermistors 214a-n and can be operatively coupled to the analog-to-digital converters (ADCs), which in the present example, can be included in the logic circuit 104. Because the electrical resistance of the NTC thermistors 214a-n varies based on temperature, voltages at the output nodes can vary proportionally to the change in resistance of the NTC thermistors 214a-n, and can be representative of corresponding temperatures sensed by the NTC thermistors 214a-n. The digitized outputs of the ADCs (corresponding to the voltages at the output nodes) can be compared to corresponding specified threshold voltage values (representative of corresponding specified temperature thresholds) for the circuit branches. In one example, the specified threshold voltage values (and specified temperature thresholds) for some or all of the branches can be identical. In one example, the specified threshold voltages (and specified temperature thresholds) can be different for some or all of the circuit branches. The voltage at the output node of each circuit branch can be used in determining whether to activate a corresponding one of the electrothermal elements 124a-n. As an example, a voltage at the output node of the first circuit branch can be compared to a first specified voltage value and if the voltage at the output node of the first circuit branch is greater than the first specified voltage (indicating the sensed temperature is below a first threshold temperature), the logic circuit 104 can output a signal to control the transistor 222a to cause the electrothermal element 124a to generate heat. As another example, a voltage at the output node of the second circuit branch can be compared to a second specified voltage value and if the voltage at the output node of the second circuit branch is greater than the second specified voltage (indicating the sensed temperature is below a second threshold temperature), the logic circuit 104 can output a signal to control the transistor 222b to cause the electrothermal element 124b to generate heat. As another example, a voltage at the output node of the n^{th} circuit branch can be compared to a n^{th} specified voltage value and if the voltage at the output node of the n^{th} circuit branch is greater than the n^{th} specified voltage (indicating the sensed temperature is below the n^{th} threshold temperature), the logic circuit 104 can output a signal to control the transistor 222n to cause the electrothermal element 124n to generate heat. In the foregoing examples, the electrothermal elements 124a-n can be individually controlled to generate heat based on whether or not a corresponding temperature sensor associated with a respective one of the electrothermal elements 124a-n senses (e.g., using the NTC thermistors) that the temperature is below a threshold temperature.

While FIGS. 3 and 4 illustrate example temperature compensation circuits of a media processing device, exemplary embodiments of the temperature compensation circuits can include more or fewer components and/or can include different components. Also, while FIGS. 3 and 4 illustrate example temperature compensation circuits of a media processing device that collectively or individually control energize and de-energize the electrothermal elements 124a-n, exemplary embodiments of the temperature compensation circuits can be configured using different schemes and/or logic to energize and de-energize the electrothermal elements 124a-n, e.g., based on circuit topologies, combinational logic, and/or other schemes. As an example, the electro thermal elements 124a and 124b can be operatively coupled to one transistor, such that the electrothermal elements 124a and 124b are energized and de-energized in unison, while the electrothermal element 124n can be operatively coupled to a different transistor such that the electrothermal element is energized and de-energized independently of the electrothermal elements 124a-b.

FIG. 4 illustrates a position of example electrothermal elements 124 relative to an embodiment of the housing 102 of the media processing device 100 in accordance with embodiments of the present disclosure. As shown in FIG. 4, the electrothermal element 124a is disposed in a housing compartment 410 of the housing 102 that receives a printed circuit board supporting electronic components (e.g., a logic circuit 104, memory 106, a communication interface 108, the input/output (I/O) devices 110, the printhead 112, the radiofrequency encoder/reader 114, the motor 116) and the power source 126, and the electrothermal element 124b is disposed in a housing compartment 420 of the housing 102 that receives a supply of media (e.g., media supply 134). The electrothermal elements 124a-b can generally cover the area defined by the compartments 410 and 420, respectively. In some embodiments, the electrothermal elements 124 can be disposed on other part of the housing 102 and/or can be support by one or more structures or frames in the housing 102. In some embodiments, the housing can include a base portion 430 and a cover portion 440, and the electrothermal elements 124 can be disposed on the base portion 430, the cover portion 440, and/or a combination of the base portion 430 and the cover portion 440. In some embodiments, the electrothermal elements 124 can be wrapped around the one or more components for which they are configured to generate heat. As an example, the electrothermal elements 124 can be wrapped around a printed circuit board, a battery, and/or a media supply.

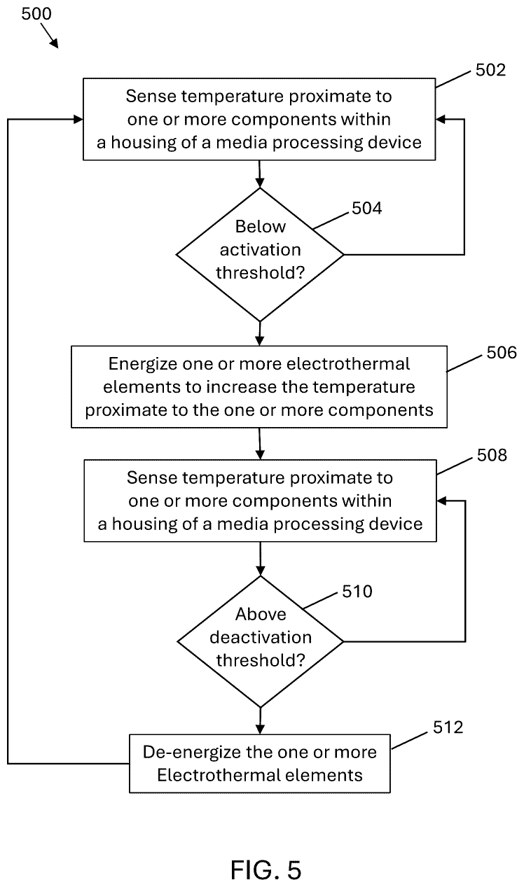

FIG. 5 is a flowchart illustrating an example process 500 for temperature compensation within a housing of a media processing device in accordance with embodiments of the present disclosure. At operation 502, a temperature proximate to one or more components within a housing (e.g., housing 102) of a media processing device (e.g., media processing device 100) is sensed (e.g., via temperature sensors 140, temperature sensing circuit 210). If the sensed temperature is above the activation threshold (at operation 504), the process 500 returns to operation 502. If the sensed temperature is below an activation threshold (at operation 504), the one or more electrothermal elements (e.g., electrothermal elements 124a-n) within the housing are selectively energized (e.g., based on a signal, a PWM signal, from the logic circuit 104) to increase the temperature proximate to the one or more components at operation 506. At operation 508, the temperature proximate to the one or more components with the housing of the media processing device is sensed. If the sensed temperature is below the deactivation threshold (at operation 510), the process 500 returns to operation 508. If the sensed temperature is above the deactivation threshold (at operation 510), the one or more electrothermal elements (e.g., electrothermal elements 124a-n) within the housing are de-energized at operation 512 and the process 500 returns to operation 502. In one example, the activation threshold (e.g., a first specified temperature threshold) and the deactivation threshold are identical (e.g., a second specified temperature threshold). In one example, the deactivation threshold (e.g., the second specified temperature threshold) is greater than the activation threshold (e.g., the first specified temperature threshold).

The above description refers to diagrams of the accompanying drawings. Alternative implementations of the example represented by the diagrams include one or more additional or alternative elements, processes and/or devices. Additionally or alternatively, one or more of the example elements of the diagram may be combined, divided, re-arranged or omitted.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device”can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A media processing device, comprising:
an electrothermal heating element;
a temperature sensor;
a printhead;
a battery;
a logic circuit operatively coupled to the electrothermal heating element, the temperature sensor, the printhead, and the battery;
a housing defining at least one compartment containing the electrothermal heating element, the temperature sensor, and at least one of the printhead, battery, the logic circuit, or a media supply,
the logic circuit configured to:
receive power from the battery;
control the printhead to perform print jobs, performance of the print jobs being degraded or inhibit below a specified temperature;
determine whether an output of the temperature sensor corresponds to a sensed temperature that is equal to or less than an activation temperature threshold; and
activate the electrothermal heating element in response to determining that the sensed temperature that is below an activation temperature threshold, the electrothermal heating element radiating heat within the at least one compartment in response to being activated.

2. The media processing device of claim 1, wherein the electrothermal heating element includes a carbon-based material.

3. The media processing device of claim 2, wherein the carbon-based material is at least one of carbon fiber, graphene, or graphite.

4. The media processing device of claim 2, wherein the electrothermal heating element is affixed to or embedded in the housing.

5. The media processing device of claim 2, wherein at least a portion of the electrothermal heating element is spaced away from the housing.

6. The media processing device of claim 1, wherein the temperature sensor includes a negative temperature coefficient (NTC) thermistor.

7. The media processing device of claim 1, wherein the logic circuit is configured to control a temperature of the electrothermal heating element when it is activated.

8. The media processing device of claim 1, wherein the activation temperature threshold is approximately zero degrees Celsius.

9. The media processing device of claim 1, wherein the activation temperature threshold is approximately negative ten degrees Celsius.

10. The media processing device of claim 1, wherein the activation temperature threshold is approximately negative fifteen degrees Celsius.

11. The media processing device of claim 1, wherein the activation temperature threshold is between negative twenty degrees Celsius and zero degrees Celsius.

12. The media processing device of claim 1, wherein the logic device is configured to:
determine whether an output of the temperature sensor corresponds to a sensed temperature that is equal to or greater than a deactivation temperature threshold; and
deactivate the electrothermal heating element in response to determining that the sensed temperature that is equal to or greater than the deactivation temperature threshold.

13. The media processing device of claim 12, wherein the deactivation temperature threshold is equal to the activation temperature threshold.

14. The media processing device of claim 12, wherein the deactivation temperature threshold is greater than the activation temperature threshold.

15. The media processing device of claim 12, wherein the deactivation temperature threshold is zero degree Celsius and seven degree Celsius.

16. The media processing device of claim 1, wherein the electrothermal heating element corresponds to a first electrothermal element and the media processing device further comprises a second electrothermal heating element.

17. The media processing device of 16, wherein the second electrothermal heating element is activated by the logic circuit in unison with the first electrothermal heating element.

18. The media processing device of 16, wherein the second electrothermal heating element is activated by the logic circuit in independently of the first electrothermal heating element.

19. The media processing device of claim 16, wherein the first compartment contains the battery and the second compartment contains the logic circuit.

20. The media processing device of claim 19, wherein the at least one compartment of the housing corresponds to a first compartment and the housing further defines a second compartment, the second electrothermal heating element is disposed in the second compartment.

21. The media processing device of claim 19, wherein the first compartment contains at least one of the battery or the logic circuit and the second compartment is configured to contain the media supply.

22. A method comprising:
sensing a temperature proximate to one or more components within a housing of a media processing device, performance of print jobs by the media processing device being degraded or inhibit below a specified temperature;
determining whether the sensed temperature is below an activation temperature threshold; and
activating the one or more electrothermal elements within the housing of the media processing device to increase the temperature proximate to the one or more components within the media processing device.

23. A media processing device, comprising:
a printhead;
a battery;
a temperature compensation circuity that includes a temperature sensing circuit and an electrothermal circuit;
a logic circuit operatively coupled to the temperature compensation circuit, the printhead, and the battery;
a housing containing the temperature compensation circuit, the printhead, the battery, and the logic circuit
the logic circuit configured to:
receive an output voltage from the temperature sensing circuit, the voltage representative of a sensed temperature;
determine whether the output voltage is indicative of a sensed temperature that is equal to or less than an activation temperature threshold; and
activate the electrothermal circuit in response to determining that the sensed temperature that is below an activation temperature threshold, the electrothermal circuit including an electrothermal heating element that radiates heat within the housing in response to the electrothermal circuit being activated.
